(19) United States
(12) Patent Application Publication
(10) Pub. No.: US 2015/0204475 A1
(43) Pub. Date: Jul. 23, 2015

(54) Bare Sleeve Pipe Repair Method And Apparatus

(71) Applicant: Carl M. Brooks, Caldwell, ID (US)

(72) Inventor: Carl M. Brooks, Caldwell, ID (US)

(21) Appl. No.: 14/601,928

(22) Filed: Jan. 21, 2015

Related U.S. Application Data
(60) Provisional application No. 61/929,644, filed on Jan. 21, 2014.

(51) Int. Cl. F16L 55/168

(52) U.S. Cl. CPC F16L 55/1683; F16L 55/1686

(57) ABSTRACT

Disclosed herein is a method and apparatus for repairing a section of compromised pipe comprising the steps of: identifying a compromised region of the pipe; cleaning the compromised region and an area of the surface of the pipe adjacent thereto; applying at least one layer of a securing material directly onto the compromised region of the pipe; applying at least one circumferential layer of a metallic cloth circumferentially encircling the pipe; applying at least one rigid partial shell to the exterior surface of the material prior to curing of the securing material; and maintaining the rigid partial shell in place until the securing material cures upon which time the securing material adheres the rigid partial shell to the pipe.

### RELATED APPLICATIONS

This application claims priority benefit of U.S. Ser. No. 61/929,644, filed Jan. 21, 2014, incorporated herein by reference.

### BACKGROUND OF THE DISCLOSURE

1. Field of the Disclosure

The object of this disclosure relates to field of repairing pipes by applying a patch to the compromised region of a section rather than replacing the compromised section.

2. Background Art

Prior art solutions to repairing of compromised pipes and similar structures containing fluid under pressure often required removal of a section of the compromised pipe.

These pipes are often used to transport hydrocarbons, including fuel, water, and sewage underground. Several repair techniques and apparatus have been attempted with varying degrees of success.

### BRIEF SUMMARY OF THE DISCLOSURE

Disclosed herein is a method and apparatus for repairing a section of compromised pipe comprising the steps of: identifying a compromised region of the pipe; cleaning the compromised region and an area of the surface of the pipe adjacent thereto; applying at least one layer of wire mesh material with a non-rigid securing material directly onto the compromised region of the pipe; the layer of wire mesh material circumferentially encircling the pipe. In one example the process includes a step of applying at least one rigid partial shell to the exterior surface of the material prior to curing of the securing material; and maintaining the rigid partial shell in place such that the non-rigid securing material adheres the rigid partial shell to the pipe.

### BRIEF DESCRIPTION OF THE SEVERAL VIEWS OF THE DRAWINGS

FIG. 1 is an isometric view of a compromised section of pipe.

FIG. 2 is an isometric view of the pipe shown in FIG. 1 with a first stage of repair in place.

FIG. 3 is an isometric view of the pipe shown in FIG. 2 with a second stage of repair being applied.

FIG. 4 is an isometric view of the pipe shown in FIG. 3 with the second stage of repair applied.

FIG. 5 is a portion of one example of a woven metallic cloth.

### DETAILED DESCRIPTION OF THE DISCLOSURE

Prior art approaches to repairs of polyethylene pipe usually focus on replacing the compromised portion of pipe with a new section of pipe. Such repairs are disclosed in U.S. Pat. No. 5,254,824 which couples the repair portion to the compromised portion using microwave technology. This process not only involves significant work in installing the repair portion, it is also problematic in the use of microwave technology for fusing a patch to a structure in the field. U.S. Pat. No. 5,613,807 requires that a hole is drilled in the compromised portion of the pipe, a patch section installed over the hole, and a vent installed over the patch. This process has significant disadvantages including that the vent sometimes cannot be shut off.

The Chevron Phillips Chemical Co. LP discloses that surface damage may occur during construction handling and installation of polyethylene pipe. Damage or butt fusion misalignment in excess of 10% may require removal and replacement of the compromised pipes section, or reinforcement with a full insert comment repair clamp. Compromised pipe cannot be “repaired” by filling compromised area with extrusion or hot gas welding. The specifications describe how a replacement is accomplished with the flanged spool or by using electro fusion or fully restrained mechanical coupling. Thus it was discovered that a convenient, easy, and permanent repair did not exist in the art and was desired.

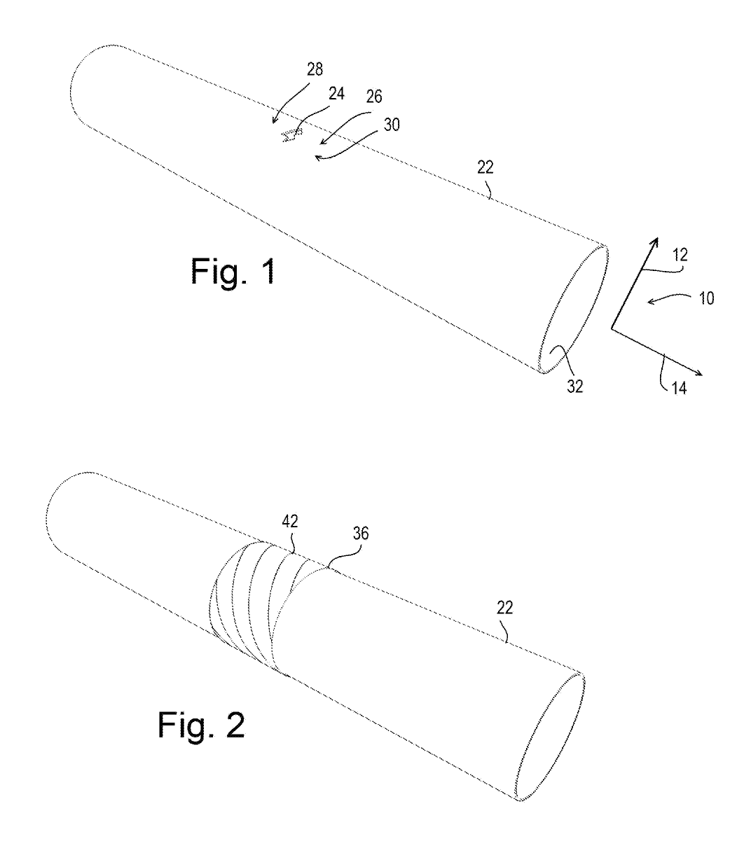

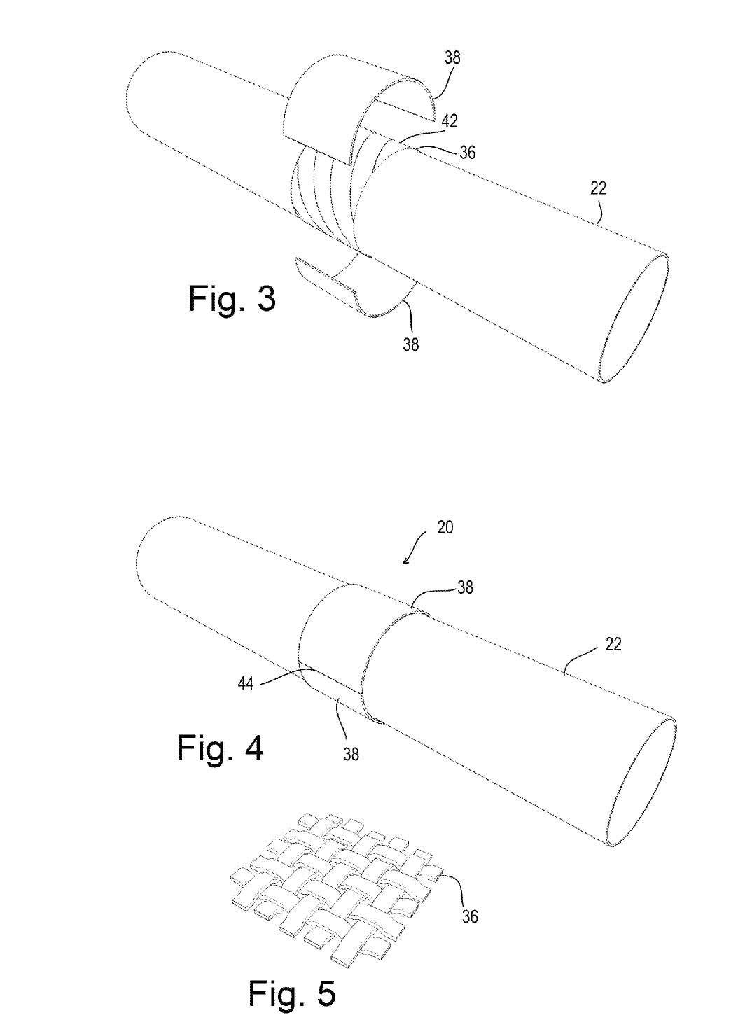

Before going into a more detailed description, an axes system 10 is provided in FIG. 1. This axes system includes a radially outward axis 12, and a longitudinal axis 14. These directions and orientations are for ease in understanding the disclosed apparatus and method and should not be construed as limiting the invention to a specific orientation.

The term “compromised” used herein meaning failed, weakened, leaking, compromised, impaired, or ruptured for the sake of continuity. While the term “pipe” is used consistently throughout this disclosure to define a substantially cylindrical structure for carrying fluids, the repair method may also be used on similar structures such as fluid holding tanks, barrels, fluid transport vehicles and equivalent structures. The term semi-rigid is used to denote structures and materials which can be flexed and bent repeatedly without breaking or cracking, but will not flow. Note that the figures are highly schematic and not drawn to scale.

In this disclosure, the term semi-rigid describes a state which when using a three point rigidity test requires a relatively small force to bend the substance; wherein the substance will not break even when flexed multiple times. The term substantially rigid describes a state which when using a three point rigidity test requires much more force to bend the substance than the semi-rigid material, and the substance may break or crack or fail when flexed multiple times.

Normal operating pressures for these pipes and fittings range from relatively low pressures for some forms such as polyethylene (PE) pipe, to relatively high pressures for other materials such as aluminum or steel. One range for PE pipe includes pressures from 20 to 100 PSI. Of course other ranges are possible depending upon the materials and construction techniques used. Steel pipe may carry fluids under pressure into the thousands pounds per square inch (PSI).

To accomplish a repair 20 to a compromised region 24 of pipe 22 utilizing one form of the example, the compromised region 24 must first be identified and accessed. During some repairs, it may be desired to substantially reduce or eliminate fluid pressure within the pipe prior to beginning such a repair. Then the compromised region 24 and surrounding areas (28/30) are normally cleaned of debris and other contaminants. Many cleaners are available for this purpose including acetone, toluene, alcohol, and the like. As the surface of pipe is often smooth, it does not allow for a firm adhesive (mechanical) bond to overlying adhesives. A non-smooth (abraded) surface is often desired. For example the user could utilize a coarse grit sandpaper (in one range 20-220 grit) to “rough up” or abrade the surface of the compromised region 24, and the adjacent area (28/30) of the pipe 22. This abraded region 26 may extend on either side of the compromised region 24 to cover an overlap portion. For example, the abraded surface 26 could extend ½″ or more on all sides of the compromised region 24.

The abraded region 26 could extend from the edge of the compromised region 24 up to the distance equal to the diameter of the pipe 22 or more. In one example, the abraded region 26 may extend around the diameter of the outer surface 30 of the pipe 22. Once again, contaminants should be removed. Once the compromised region 24 and overlap portions 28/30 are sufficiently abraded, the pipe 22 adjacent the compromised region 24 may be heated such as by a propane or acetylene torch or heat gun. The pipe 22 may be heated up to 100°, 180° or more. A roll or press perforator, which is a tool designed to dispose a number of small perforations or indentations in a surface may also be utilized on the abraded region 26. These perforator devices are known in the art of laying of fiberglass material such as for boat building and often comprise a wheeled portion with a number of needle-like projections such that the tool can be “rolled” or “pressed” into the surface and provide a number of perforations which may not extend through the interior wall 32 of the pipe 22. These perforations or indentations further improve a good adhesion of the repair patch to the pipe 22.

In some cases, the compromised portion 24 may extend completely through the wall of the pipe 22 including the interior wall 32 of the pipe 22. In these cases, it may be desired to first substantially reduce or eliminate fluid pressure differential from the interior portion of the pipe 22 to atmosphere. The fluid passing through the pipe 22 may contain hydrocarbons or other fluids which may hinder or prohibit curing or adhesion. Once these initial steps are accomplished, a rigid or semi-rigid plug could be inserted into or through the compromised portion 24. The plug may extend into the interior wall 32 of the pipe 22. This insertion of a plug could be facilitated by a clamp such as a pipe clamp, c-clamp, and the like. The plug could alternatively or additionally be adhered in place. The compromised portion 24, areas adjacent regions 28 and 30, the plug, and the circumferential portion should all be cleaned of contaminants.

It may be desired to provide a plug made out of a soft, semi-rigid malleable material such as synthetic rubber, acrylic adhesive, or the like which would be relatively easy to install and conform to the compromised portion, and would have additional advantages. The plug, if projecting into the interior wall 32 of the pipe 22, may slightly disrupt the fluid flow through the pipe 22, but not substantially.

In use of some pipes, especially larger pipes used for gas, oil, or water, a sensor device called a “pig” is inserted into the pipe 22 to run the length and check for damage and blockages. Using a plug material with very low shear strength would ensure that as the pig passes the plug, the pig would “shear off” the portion of the plug extending through the interior wall 32 without damaging the pig.

In one example, once the compromised region 24 and adjacent regions 28/30 are prepared, a securing compound 42 may be added directly to the surface of the pipe 22 over and adjacent the compromised region 24. The securing compounds used effectively cure to a semi-rigid state such that that temperature fluctuations and physical movement of the repair 20 will not cause the repair to become brittle and disassociate from the surface of the compromised pipe. Testing has shown that common epoxies and adhesives which are designed to adhere to some pipes and surfaces, especially polyethylene and high density polyethylene, cure to a hard and rigid state. These adhesives failed in time, and needed to be repaired again. As stated before, many structures such as polymer pipes bend and flex due to movement and/or temperature fluctuations. Rigid adhesives cannot flex and thus crack and break over time. Other adhesives may cure to a nearly fluid state and thus do not form a permanent bond to the failed structure as movement tends to disassociate the outer material layers and/or the surface of the structure from the adhesive.

Once the compromised portion 24 is properly prepped for the next step of the repair, in one form of the repair 20 a layer of securing compound (adhesive) 42 is disposed circumferentially around the pipe 22, as shown in FIG. 2. A circumferential layer of metallic cloth is then “worked in” to the securing compound 42. It may be desired to extend this layer of securing compound beyond the compromised portion 24.

In one example, once the securing compound 42 is applied, one or more layers of metallic cloth 36 are applied over the securing compound 42. Such metallic cloth 36 may be individual woven or pressed strands of metallic fibers woven or pressed to an open screen metallic cloth 36. Woven indicating as shown in FIG. 5 where one lateral fiber passes over a first transverse fiber, and then under an adjacent transverse fiber etc. When the metallic cloth is applied to the securing compound 42, the securing compound will work between the individual fibers of the metallic cloth 36, thus holding the metallic cloth 36 in place on the compromised region 24. The metallic cloth 36 provides tensile strength to the repair 20. It may also be desired to “build up” several layers around the pipe 22 by alternating as many as 15 or more layers of securing compound 42 and metallic cloth 36. This can be accomplished by multiple strips of metallic cloth 36 or may be a single strip metallic cloth 36, as shown in FIG. 2; for example. These wraps may be straight or linearly circumferential in what is called a “cigarette wrap” or may be diagonal as shown in FIG. 2 in what is called a “spiral wrap.” During application, the securing compound 42 will tend to “work in” between the strands of the metallic cloth 36 forming a cohesive interoperating structure which is semi rigid and allows for flexing and thermal expansion/contraction while the metallic cloth itself.

The term metallic used herein is intended to cover steel, copper, aluminum, alloys and other metals as well as equivalents such as carbon fiber. As fiberglass (Glass reinforced polyester matrix) has an elastic modulus of 17 (10⁹ N/m², GPa) and Structural Steel (ASTM-A36) has an elastic modulus of 200 (10⁹ N/m², GPa), it is clear the structural advantages of metallic cloth over fiberglass (FRP) in the application of the repair 20.

It may also be desired to have one or more of the layers being formed of a first type of material such as the metallic cloth 36 with securing compound 42, and further outer layers being comprised of a different material and/or a different adhesive. Different fibrous materials and adhesives may be utilized as the adhesive in contact with the outer surface of the pipe 22 are selected to provide a flexible and adhesive bond to the pipe 22, and the outer layers selected to form a more rigid, weather protecting, and structural wrap to increase hoop strength of the overall repair.

While the term adhesive is generally used to describe this second adhesive, a substantially rigid cast-like substance could also be utilized. Such a cast-like substance may not adhere to any surface of the structure, or may adhere to structures made of some substances, but would in either case hold adjacent fibers in relative position when cured to a substantially rigid state.

One or more partial shells 38 may be applied to the radially outward surface of the metallic cloth 36/securing compound 42. The partial shell(s) 38 will then be held in place and add hoop strength to the repair 20. In one form clamps such as the clamps disclosed in U.S. patent application Ser. No. 13/749,467 may be utilized for such purposes.

In one form, the inner surface of the shells is substantially equivalent in diameter to the outer surface of the pipe, such that when the shells are clamped in place with the metallic cloth 36 and securing compound 42 there between the pipe and repair are forced into compression. Thus, when pressure is applied to the inner surface of the pipe as the fluid pressure in the pipe is increased, no significant outward deformation of the repair 20 occurs.

These partial shells 38 may then be edge welded 44 if necessary to permanently secure the partial shells 38 in place.

The entire repair process beginning to end can be accomplished in 30 minutes or less depending on several factors, including pipe diameter. This is substantially less than most prior art solutions and involves substantially less cost not only in repair materials, but also in labor and downtime. When the repair has been completed in an excavated area on an exposed section of pipe, the exposed portion of pipe can be backfilled in as little as one hour or less depending on the adhesive utilized, ambient temperature, and humidity.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

1. A method for repairing a section of compromised pipe comprising the steps of:
a. identifying a compromised region of the pipe;
b. cleaning the compromised region and an area of the surface of the pipe adjacent thereto;
c. applying at least one layer a securing material directly onto the compromised region of the pipe;
d. applying at least one circumferential layer of metallic cloth over the securing material such that the securing material flows radially between fibers of the metallic cloth; and
e. the layer of metallic cloth circumferentially encircling the pipe.

2. The method as recited in claim 1 further comprising the steps of:
a. applying at least one rigid partial shell to the exterior surface of the material prior to curing of the securing material; and
b. maintaining the rigid partial shell in place until the securing material cures upon which time the securing material adheres the rigid partial shell to the pipe.

3. The method as recited in claim 1 wherein the securing material is an adhesive which cures to a semi-rigid state.

4. The method as recited in claim 1 wherein the metallic cloth is formed of woven metallic fibers.

5. The method as recited in claim 1 wherein the metallic cloth is formed of pressed metallic fibers.
